(19) United States
(12) Patent Application Publication
(10) Pub. No.: US 2026/0350423 A1
(43) Pub. Date: Nov. 5, 2026

(54) SYSTEM AND METHOD FOR AUTOMATICALLY DETERMINING ONTOLOGY WITH GENERATIVE ARTIFICIAL INTELLIGENCE

(71) Applicant: Nice Ltd., Ra'anana (IL)

(72) Inventors: Robert William MORRIS, Atlanta, GA (US); Jon Augustus ARROWOOD, Smyrna, GA (US)

(73) Assignee: Nice Ltd., Ra'anana (IL)

(21) Appl. No.: 19/196,126

(22) Filed: May 1, 2025

(51) Int. Cl. G06N 5/022; G06F 16/36

(52) U.S. Cl. CPC G06N 5/022; G06F 16/367

(57) ABSTRACT

A system and method for automatically creating ontology for use with agent-client interaction systems. The systems and method can receive transcripts of agent and client interactions, and use a first large language model (LLM) to generate intents based on the transcripts. The intent can be used for a second LLM to generate the ontology based on the intents. A third LLM can map intents based on the ontology. A fourth LLM can be used to determine phrases to add to the mapped intents to create a final ontology. The final ontology can be transmitted to an agent-client interaction system.

### TECHNICAL FIELD OF THE INVENTION

The present invention relates generally to ontology generation. In particular, to automatically generating ontology with generative artificial intelligence for use with agent-client interaction systems.

### BACKGROUND OF THE INVENTION

Currently, various computing systems use ontologies for processing. Typically, ontology categories are created manually by, for example, an individual or teams of individuals manually curating files for the ontology. In some scenarios there can be hundreds of different categories in any ontology. In some systems, it can take teams of individuals many weeks to create ontology. Existing systems can also have problems with ontology precision due to, for example, human error in category selection, typographical errors, and/or inability to identify rare events due to, for example, manual review of random samples.

Therefore, it can be desirable to create ontology automatically with a repeatable, accurate process that allows for significantly shortened timeline.

### SUMMARY OF THE INVENTION

Advantages of the invention can include an automatic repeatable accurate ontology creation. Advantages of the invention can include ontology created in a manner of minutes in comparison to hours. Advantages of the invention can also include agent-client interaction systems mor accurately selecting which agent to route interaction to based on the ontology.

Advantages of the invention can include improved quality of the output for each customer in comparison to manual methods of building the ontology.

Advantages of the invention can include significant reduction in labor costs as compared to current methods due to, for example, absence of human input (or substantially minimal human input).

Significantly reduced time to value because more clients can be onboarded and served faster, increasing CSAT, reducing costs, and overall scaling the business.

In one aspect, the invention involve a method for automatically creating ontology for use with agent-client interaction systems. The method can involve receiving, by a computer, a plurality of transcripts, wherein each transcript includes agent and client interactions. The method can also involve generating, by the computer, via a first large language model (LLM) intents based on the plurality of transcripts. The method can also involve generating, by the computer, via a second LLM the ontology based on the intents. The method can also involve mapping, by the computer, via a third LLM the intents based on the ontology. The method can also involve determining, by the computer, via a fourth LLM phrases to add to the mapped intents based on the ontology to create a final ontology map, wherein the phrases are used in expressing the intent. The method can also involve transmitting, by the computer, the final ontology map to the agent-client interaction system for use with new interactions.

In some embodiments, the ontology comprises for each of the intents, a topic and a category, wherein each topic belongs to a category. In some embodiments, each of the phrases has corresponding speaker turn information.

In some embodiments, determining the phrases involves i) extracting titles and phrases from a base ontology, ii) extracting titles and speaker turns from the generated ontology, iii) determining a similarity between the titles from the base ontology and titles from the generated ontology, iv) selecting a predetermined number of titles that have a highest similarity, v) for each selected title, creating a combined intent that includes phrases from the base ontology and title and speaker turn from the generated ontology to create a number of combined intents equal to the predetermined number, and vi) determining a final ontology map via a fifth LLM that determines the phrases for each mapped intent after the fifth LLM processes the combined intents.

In some embodiments, the similarity is based on a cosine similarity.

In some embodiments, the method involves receiving, by the agent-client interaction system, the final ontology map and a real-time interaction request, determining, by the agent-client interaction system, an intent of the real-time interaction request, mapping, by the agent-client interaction system, the intent to one or more topics, one or more categories, or both based on the final ontology map, determining, by the agent-client interaction system, an agent that excels at the intent, the one or more topics, the one or more categories, or any combination thereof, and automatically routing, by the agent-client interaction system, to the determined agent.

In some embodiments, the method involves determining an agent that excels at the intent is based on agent history with the intent, one or more topics, or the one or more categories sentiment, based on satisfaction or any combination thereof. In some embodiments, creating the final ontology map involves for each intent in the final ontology map, renaming the intent based on a similarity between the intent and the corresponding phrases.

In some embodiments, upon receipt of the plurality of transcripts, each transcript is shortened to include a maximum number of client statements. In some embodiments, the predetermined number is 3 or higher.

In another aspect, the invention involves a system for automatically creating ontology for use with agent-client interaction systems. The system includes a processor configured to receive a plurality of transcripts, wherein each transcript includes agent and client interactions. The system can also include generate via a first large language model (LLM) to generate intents based on the plurality of transcripts. The system can also include generate via a second LLM the ontology based on the intents. The system can also include map via a third LLM the intents based on the ontology. The system can also include determine via a fourth LLM phrases to add to the mapped intents based on the ontology to create a final ontology map, wherein the phrases are used in expressing the intent, the processor configured to transmit the final ontology map to the agent-client interaction system for use with new interactions.

In some embodiments, the ontology comprises for each of the intents, a topic and a category, wherein each topic belongs to a category. In some embodiments, each of the phrases has corresponding speaker turn information.

In some embodiments, determining the phrases can also include the processor configured to i) extract titles and phrases from a base ontology, ii) extract titles and speaker turns from the generated ontology, iii) determine a similarity between the titles from the base ontology and titles from the generated ontology, iv) select a predetermined number of titles that have a highest similarity, v) for each selected title, create a combined intent that includes phrases from the base ontology and title and speaker turn from the generated ontology to create a number of combined intents equal to the predetermined number, and vi) determine a final ontology map via a fifth LLM that determines the phrases for each mapped intent after the fifth LLM processes the combined intents.

In some embodiments, the similarity is based on a cosine similarity. In some embodiments, the system also includes receive, by the agent-client interaction system, the final ontology map and a real-time interaction request, determine, by the agent-client interaction system, an intent of the real-time interaction request, map, by the agent-client interaction system, the intent to one or more topics, one or more categories, or both based on the final ontology map, determine, by the agent-client interaction system, an agent that excels at the intent, the one or more topics, the one or more categories, or any combination thereof, and automatically route, by the agent-client interaction system, to the determined agent.

In some embodiments, determine an agent that excels at the intent is based on agent history with the intent, one or more topics, or the one or more categories sentiment, based on satisfaction or any combination thereof.

In some embodiments, creating the final ontology map can include for each intent in the final ontology map, renaming the intent based on a similarity between the intent and the corresponding phrases. In some embodiments, upon receipt of the plurality of transcripts, each transcript is shortened to include a maximum number of client statements. In some embodiments, the predetermined number is 3 or higher.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is flowchart for a method for automatically creating ontology for use with agent-client interaction systems, according to some embodiments of the invention.

FIG. 3 shows an example of a method for generating a multi-shot prompt, according to some embodiments of the invention.

FIG. 4 is an example of a system architecture for an agent-client interaction system with ontology based AI routing, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

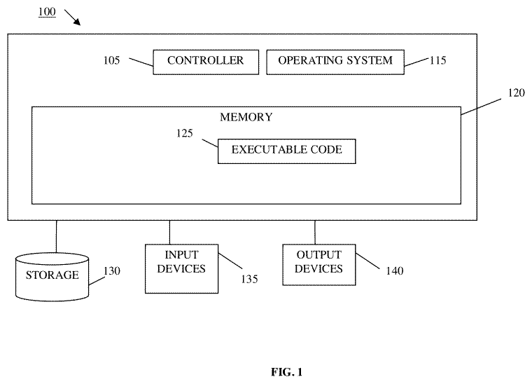

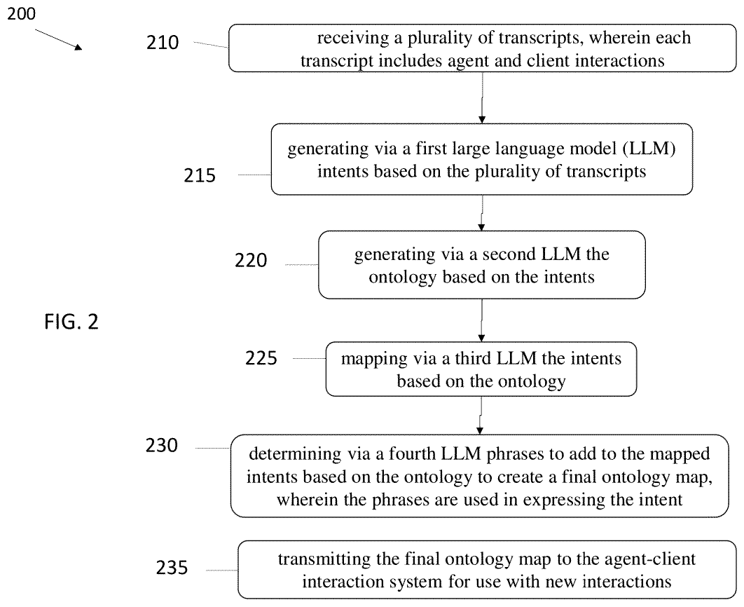

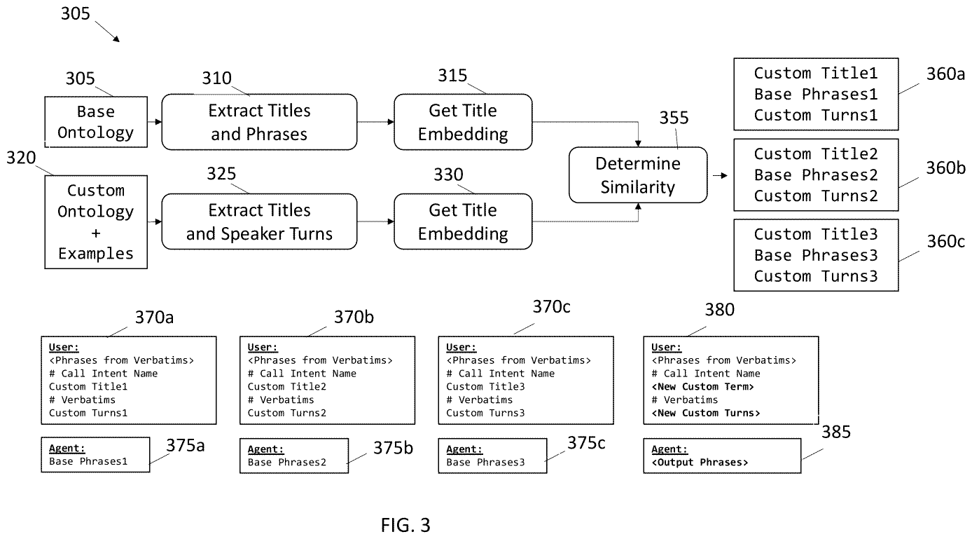

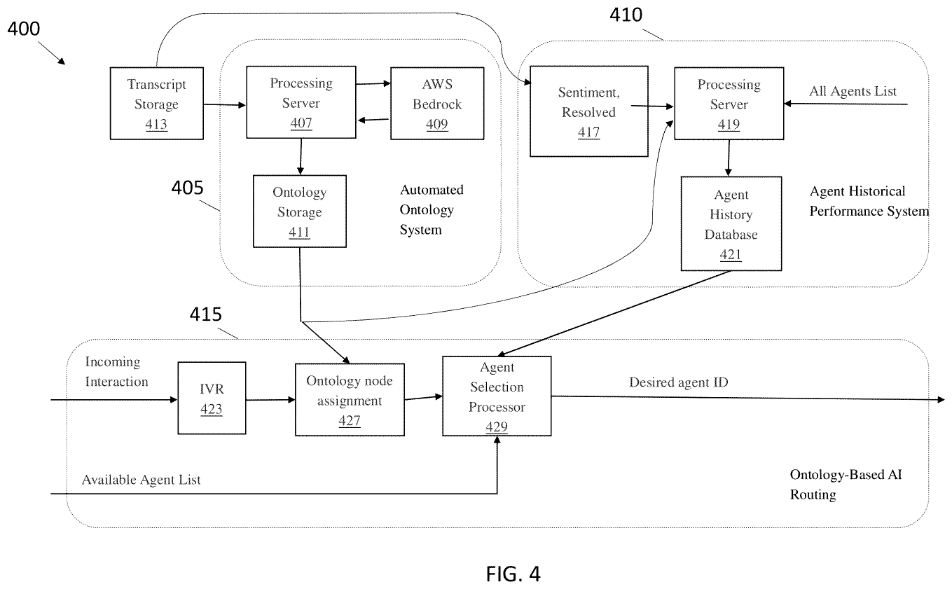

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. as shown in FIG. 4 described below and modules and processes in FIG. 2 or 3 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 2 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

In general, the invention involves tagging each interaction (e.g., data associated with the interaction) that flows through a given computing system (e.g., multi-regional call center) with a dynamically generated compliance rule. The dynamically generated compliance rule can include information that allows compliance with data laws, including rules dictating storage, retention, security and/or transfer of the interaction data. Generating the compliance rule dynamically for each interaction can allow for any updates made to the laws to be integrated into how each interaction is handled in real-time and/or can allow for adjusting compliance for previously stored interactions. Generally, the invention can also involve selection a region when multiple regions can apply based on a strictness score which can account for level of compliance, cost and/or performance.

FIG. 2 is flowchart 200 of a method for automatically creating ontology for use with agent-client interaction systems, according to some embodiments of the invention.

The method can involve receiving, by a computer (e.g., computing device 100), a plurality of transcripts, wherein each transcript includes agent and client interactions (Step 210). A number of the plurality of transcripts can be on the order of 1 k-10 k. The transcripts can be automatically recorded during agent/client interactions. The transcripts can be for a particular organization/company.

Each turn in a transcript can include a data structure as is shown in Table 1:

TABLE 1

| Variable name | Descriptor |
|---|---|
| Filename | Identifier for call or chat |
| Party | string: Party in conversation (Agent, |
| | Customer, Unknown) |
| Line Number | int: Zero-indexed line into transcript |
| Text | Actual text of speaker turn |

The method can involve generating, by the computer, via a first large language model (LLM) intents based on the plurality of transcripts (Step 215). The first LLM can be an Anthropic Sonnet 3.5. In various embodiments, the first LLM is ChatGPT4o, Llama3.1 405B, or Gemini 2.0

The prompt input to the first LLM can provide a description of the plurality of transcripts format and a request for an output of intent and line number.

The prompt input to the first LLM can be as shown in Table 2:

TABLE 2

| | |
|---|---|
| Prompt | I will provide a transcript, and I would like to pick up to three intents that best |
| | describe the reason the customer has called. Make the intents a {min_words}- |
| | {max_words} word description. The output format is a CSV, with each line |
| | following the <Output Format> section and should include the intent, and the |
| | relevant line number from the transcript from the customer side. Try to avoid |
| | repeating intents. Please do not include additional commentary, just the output |
| | CSV. The transcript is in <Transcript> section and is formatted |
| | “<Line_number>: <side>:<text>”. The Transcript is generated by speech |
| | recognition and contains errors. |
| | <Output Format> |
| | intent,Line_number |
| | </Output Format> |
| | <Transcript> { conv} </Transcript>. |

Each intent can be a single sentence from the respective agent/client interaction and a line number that indicates where in the respective agent/client interaction the single sentence occurred.

Table 3 is an example of a plurality of intents output from the first LLM with corresponding line numbers and file names.

TABLE 3

| Intent | Line | Filename |
|---|---|---|
| Update credit card information error | 18 | 000878f7 |
| Changing home location | 5 | 000be00f |
| Providing billing address | 25 | 000be00f |
| Can't log in due to forgotten password | 1 | 00c50ab8 |
| Password reset request | 24 | 00c50ab8 |
| Cancel Hulu account due to lack of use | 1 | 00d5d55c |
| Specific channel/program due to plan | 0 | 00a7291a |

Each intent can include a data structure as is shown in Table 4:

TABLE 4

| Variable | Description |
|---|---|
| Filename | string: Identifier for call or chat |
| Line Number | int: Zero-indexed line into in transcript |
| Text | string: The free-form description of the caller |
| | intent |
| L1 | Optional(string): If given, represents the first |
| | level Category for the intent. |
| L2 | Optional(string): If given, represents the |
| | second level Topic for the intent |
| L3 | Optional(string): If given, represents the |
| | third level intent name for the intent. |

The method can involve generating, by the computer, via a second LLM the ontology based on the intents (Step 220). The intents can be input to the second LLM along with a prompt. In various embodiments, a number of intents is from 1 to 3,000. In some embodiments, a number of intents based on context window limitations of the second LLM. In some embodiments, heuristics (e.g., number of intents, guidance on wording and instructions to avoid Personally Identifiable Information (PII)) are provided to the second LLM

The prompt input to the second LLM can be a list of reasons for the customer calls and a request to provide an output in an hyphenated format.

The prompt input to the second LLM can be as shown in Table 5:

TABLE 5

| | |
|---|---|
| Prompt | I will present a list of reasons in <InputReasons> for customer calls. Make |
| | sure there are three levels and follow <Output_Format>. I would like to have |
| | a total of {max_l3} Level 3 intents. Keep the Level 3 intents short, removing |
| | things like “Customer needs”. If the intents contain any personal information, |
| | please ignore them to avoid any PII getting in categorization. Make sure there |
| | are no Level 2 topics with no Level 3 children. |
| | <Output_Format> |
| | - Level 1 category |
| | - Level 2 topic |
| | - Level 3 intent |
| | </Output_Format> |
| | <InputReasons> |
| | {reasons_str} |
| | </InputReasons> |

Table 6 is an example of the output ontology resulting from the prompt shown in Table 3.

TABLE 6

| | |
|---|---|
| Ontology | Account Management |
| | - Account Access |
| | - Account locked |
| | - Multiple accounts |
| | - Profile issues |
| | Sports and Live Events |
| | - Game Access |
| | - Channel availability |
| | - TV provider login |
| | - Team/league access |

As can be seen in Table 4, “Account Management” is the Level 1 category; “Account Access” is the Level 2 topic; and “Account Locked,” “Multiple Accounts,” and “Profile issues” are the Level 3 intents. “Sports and Live Events” is the Level 1 category; “Game Access” is the Level 2 topic; and “Channel availability,” “TV provider login, and” “Team/league access” are the intents.

In various embodiments, each category has one or more corresponding topics and/or each topic has one or more corresponding intents.

Each ontology can include a data structure as is shown in Table 7:

TABLE 7

| Variable | Description |
|---|---|
| L1 | string: The first level category for the intent |
| L2 | string: The second level topic for the intent |
| L3 | string: The third level intent name for the |
| | intent |
| Phrases | List(string): A list of phrases that are used by |
| | customer in expressing an intent |

The method can involve mapping, by the computer, via a third LLM the intents based on the ontology (Step 225). The input to the third LLM can be the ontology (e.g., three-level hierarchy of category, topic and intents) and the intents as shown above in Table 2. The third LLM can map the intents into the ontology.

In some embodiments, duplicates can be removed from the intents, a unique identifier can be added to each intent.

The prompt for the third LLM can be as shown below in Table 8:

TABLE 8

| | |
|---|---|
| Prompt | I have a three-level categorization in the Categories section, followed |
| | by a list of numbered call reasons in Input Reasons section. I would |
| | like to create a CSV with 6 columns that contain: |
| | * Reason number |
| | * Input reason |
| | * L1 - L2 - L3 categorization that best matches. |
| | * Score 1-5 of how sure you are about the L1 - L2 - L3 match |
| | * Score 1-5 of how sure you are about the L1 - L2 match |
| | * Score 1-5 of how sure you are about the L1 match |
| | Pick a single “L1 - L2 - L3” categorization. Be careful not to include |
| | commas in the categorization. Make sure to include all 3 levels. |
| | <Categories> |
| | - Junk |
| | - Unrelated |
| | - Not Business related |
| | - Not intent |
| | - Authentication |
| | - Authenticating user |
| | - Getting user information |
| | - Customer verification |
| | - Misc |
| | - Call greetings |
| | - Unable to understand |
| | - Explaining call |
| | - Confirming understanding |
| | - Request agent |
| | - Customer providing information |
| | - Intent too general |
| | {categories} |
| | </Categories> |
| | <Input Reasons> |
| | {reasons_str} |
| | </Input Reasons> |

The output of the third LLM can be group together by intent. In some embodiments, a “junk” category can be defined (e.g., as input by a user) to match with the output of the third LLM such that matches are filtered out of the output.

The output of the third LLM can be as shown below in Table 9.

TABLE 9

| Intent | Line | Mapped |
|---|---|---|
| Update credit card information | 18 | Account Management - Account Updates - |
| error | | Update payment method |
| Changing home location | 5 | Account Management - Account Updates - |
| | | Home location change |
| Providing billing address | 25 | Account Management - Account Verification - |
| | | Provide account information |
| Can't log in due to forgotten | 1 | Account Management - Login Issues - Forgot |
| password | | password |
| Password reset request | 24 | Account Management - Login Issues - |
| | | Reset password |
| Cancel Hulu account due to | 1 | Subscription Management - Cancellations - |
| lack of use | | Cancel subscription |
| Specific channel/program due | 0 | Subscription Management - Plan Changes - |
| to plan | | Change plan |

The method can involve determining, by the computer, via a fourth LLM phrases to add to the mapped intents based on the ontology to create a final ontology map, wherein the phrases are used in expressing the intent (Step 230).

The input to the fourth LLM can be the ontology determined in step 225, intents mapped into hierarchy as determined in step 230, transcripts for intents (e.g., plurality of transcripts as described above) and/or a default ontology (e.g., as input by a user).

The phrases can be determined based on a one-shot prompt or a multi-shot prompt.

A prompt for a one shot prompt can be as shown in Table 10 below:

TABLE 10

| | |
|---|---|
| Prompt | I have a set of verbatims where I would like to pull a comma delimited |
| | list of phrases that capture the essence of <intent>. Please output a |
| | single line with just the phrases, without any additional commentary. |
| | Include up to {max_phrase_count} best phrases. Try to include as |
| | many variations as possible. |
| | Output is {min_phrase_len} to {max_phrase_len} word sequences |
| | from the transcripts. Try to avoid single words if possible. |
| | If a phrase has less than {min_phrase_len} words use the context from |
| | the verbatim to make it longer. |
| | Avoid anything that has specific dates, names, numbers, special |
| | characters, or e-mail addresses. |
| | Do not include numbers or any non alphabetic characters like @ or /. |
| | Make phrases specific enough to discriminate between other intents, |
| | this could mean making it longer. |
| | Prefer phrases that come from the <verbatims> section. |
| | Remove unnecessary language like “i need to”, “want to”, “please”. |
| | For example, we want “cancel my appointment” instead of “i'd like to |
| | cancel my appointment” |
| | We also want to avoid phrases that are included in <Other_Intents> |
| | section. |
| | We only want phrases that are relevant to the <intent>, and not the |
| | others. |
| | <Other_Intents> |
| | {all_others} |
| | </Other_Intents> |
| | <intent> |
| | {intent_name} |
| | </intent> |
| | <verbatims> |
| | {all_verbatims} |
| | </verbatims> |

Turning to FIG. 3, FIG. 3 shows an example of a method 300 for generating a multi-shot prompt, according to some embodiments of the invention.

The method can involve extracting titles and phrases from a base ontology 305 (Step 310). The base ontology 305 can be input by a user. The base ontology 305 can be an ontology that includes common intents of an agent and customer interaction (e.g., as seen in call centers). The common intents can be common across many call centers (e.g., I'd like to change my password).

The titles of the base ontology can be in the form string “<L1>-<L2>-<L3>”. Each title can include a corresponding intent.

The method can involve embedding the titles (Step 315). The embedding of the titles can be determined by a phrase and embedding tool as is known in the art (e.g., Cohere English Embedding in Amazon Bedrock). The embedding can produce a 1024-dim vector of floating point numbers.

The method can involve extracting titles and speaker turns for each intent from a custom ontology 320 (Step 310). The custom ontology can be the ontology as determined in FIG. 2 above in step 220.

The method can involve embedding the titles (Step 330). The embedding of the titles can be determined by Cohere English Embedding in Amazon Bedrock. The embedding can produce a 1024-dim vector of floating point numbers.

The method can involve determining a similarity between the embedding created from the base ontology and the embedding created from the custom ontology (Step 335). The similarity can be determined by a cosine similarity score. The base and custom intents having the top cosine similarity can be selected. Each pair can be used to create a multi-shot prompt. For example, Table 11 shows an example base and custom intent that can be used to create the multi-shot prompt.

TABLE 11

| Base intent | Custom intent |
|---|---|
| L1: str | L1: str |
| L2: str | L2: str |
| L3: str | L3: str |
| Title: str: L1-L2-L3 | Title: str: L1-L2-L3 |
| Phrases: List[str] | Turns: List[str] |
| Title Embedding: Vector[float] | Title Embedding: Vector[float] |

The title and turns from the custom intent (e.g., client turns) and the phrases (e.g., agent phrases) from the base intent can be grouped as shown in FIG. 3 as output 360a, 360b, and 360c.

The output 360a, 360b and 360c can be used to create agent and client phrases 370a, 375a, 370b, 375b and 370c, 370c input to the fourth LLM.

In this manner, upon receipt of the prompt 380 that does not include a corresponding agent base phrase, with a request for the agent phase, the fourth LLM can output agent phrase 385 that is more accurate then without the multi-shot phrase creation.

In some embodiments, there are two sets of prompts to obtain extracting phrases, a first set of prompts is with verbatims and second set of prompts when verbatims are not available.

For example, Table 12 shows an example of a first set of prompts having verbatims, and Table 13 shows an example of a second set of prompts without verbatims.

TABLE 12

| | |
|---|---|
| Prompt | I have a set of verbatims where I would like to pull a comma delimited |
| | list of phrases that capture the essence of <intent>. Please output a |
| | single line with just the phrases, without any additional commentary. |
| | Include up to {max_phrase_count} best phrases. Try to include as |
| | many variations as possible. |
| | Output is {min_phrase_len} to {max_phrase_len} word sequences |
| | from the transcripts. Try to avoid single words if possible. |
| | If a phrase has less than {min_phrase_len} words use the context from |
| | the verbatim to make it longer. |
| | Avoid anything that has specific dates, names, numbers, special |
| | characters, or e-mail addresses. |
| | Do not include numbers or any non alphabetic characters like @ or /. |
| | Make phrases specific enough to discriminate between other intents, |
| | this could mean making it longer. |
| | Prefer phrases that come from the <verbatims> section. |
| | Remove unnecessary language like “i need to”, “want to”, “please”. |
| | For example, we want “cancel my appointment” instead of “i'd like to |
| | cancel my appointment” |
| | We also want to avoid phrases that are included in <Other_Intents> |
| | section. |
| | We only want phrases that are relevant to the <intent>, and not the |
| | others. |
| | <Other_Intents> |
| | {all_others} |
| | </Other_Intents> |
| | <intent> |
| | {intent_name } |
| | </intent> |
| | <verbatims> |
| | {all_verbatims} |
| | </verbatims> |

TABLE 13

| | |
|---|---|
| Prompt | I would like to create a comma delimited list of short phrases that |
| | captures the essence of the “Call Intent Name”. |
| | These will be short (min_phrase_len} to {max_phrase_len] word |
| | sequences. |
| | Avoid anything that has specific dates. |
| | Make phrases specific enough to discriminate between other intents. |
| | Please output a single line with just the phrases, without any additional |
| | commentary. |
| | Include up to {max_phrase_count} best phrases, |
| | Remove any phrases that don't make sense with the intent name. |
| | Avoid phrases that are too specific. Remove unnecessary language |
| | like “i need to”, “want to”, “please”, |
| | For example, we want “cancel my appointment” instead of “i'd like to |
| | cancel my appointment”. |
| | We also want to avoid phrases that are included in “Other Intents” |
| | section. So if there is a “reschedule appointment” in “Other Intents”, |
| | do not include in the final list. |
| | Try to avoid single words if possible. |
| | We only want phrases that are relevent to the “Call Intent Name”, and |
| | not the others. |
| | <Other_Intents> |
| | {all_others} |
| | </Other Intents> |
| | <intent> |
| | {intent_name} |
| | </intent> |

In some embodiments, the final ontology can be further refined, for example, to assist in ensuring that the phrases are associated with the best (or better) intents. For example, the phrase “the address on the new card” may have been associated with the intent “update address,” however, the best (or better) intent may be “update payment information.”

Refining the ontology can involve comparing each phrase with its respective intent and determining a similarity between them. If the similarity is below a threshold then the intent can be renamed.

Each phrase and intent can be embedded using Amazon Bedrock Cohere Models, and a phrase vector created. The cosine similarity between each phrase and intent can be determined, and phrases/intent pairs with the best scores can be mapped to one another. Then each intent can be input to a LLM for renaming to, for example, ensure that the phrases are mapped to the intent with the highest scores.

The prompt for the renaming can be as shown below in Table 14:

TABLE 14

| | |
|---|---|
| Prompt | We have a list of call intents that describe what a customer is calling |
| | about. |
| | We would like to translate them into present participle tense, title |
| | casing using Chicago style rules, and American spelling (except |
| | doubling l's in things like cancelling). |
| | Make sure the output list is the same length as the input, with no |
| | additional commentary. |
| | Start each output intent with ″- ” |
| | Here is the list: |
| | {intents} |

Turning back to FIG. 2, the method can involve transmitting, by the computer, the final ontology map to the agent-client interaction system for use with new interactions (Step 235).

In some embodiments, the ontology can be used for ontology-based artificial intelligence (AI) agent routing. For example, client can call an automated system and speak for 30 seconds. The ontology can be used to determine based on that 30 seconds the one or more categories, the one or more topics and/or the one or more intents of the client. The client can be routed to an agent that has a historical record as being competent at handling a particular category, topic or intent according to the ontology (e.g., takes a short time resolve, has a high level of client satisfaction, has a low call-back rate, etc.).

For example, turning FIG. 4 is an example of a system architecture for an agent-client interaction system with ontology based AI routing, according to some embodiments of the invention. The system can include an automated ontology system 405, an agent historical performance system 410, and a ontology based AI-routing system 415.

The automated ontology system 405 can include processing server 407, AWS Bedrock 409 and ontology storage 411.

The processing server 407 can read transcripts from a transcript storage 413 and process the transcripts to create the ontology. The processing server 407 can perform the ontology creation as described above with respect to FIG. 2 and FIG. 3. The processing server 407 can communicate with the AWS Bedrock 409 through an AWS Bedrock API. The processing server 407 can store the created ontology in the ontology storage 411.

The ontology storage 411 can store the ontology in any text, spreadsheet, and/or database format.

The transcript storage 413 can include transcripts for interactions created by automatic speech recognition and/or chat transcripts. There can be a file for each transcript or all the transcripts in one database.

The transcript storage 413 and ontology storage 411 can communicate with the agent historical performance system 410 by sending transcripts and/or ontology.

The agent historical performance system 410 can include sentiment, resolved module 417, processing server 419 and agent history database 421. The sentiment, resolved module 417 can have as input historical customer interactions, both text or text-from-speech-recognition-on-audio. The sentiment, resolved module 417 can analyze its inputs for dimensions such as customer sentiment, representative satisfaction, was the issue resolved, handle time for the interaction, sales goals, and/or any other metric that can either be directly derived from metadata (such as using a survey result for rep satisfaction) or from modeling (such as running machine learning on text to determine sentiment).

The processing server 419 can receive a list of all agents as input and can aggregate per-interaction metrics at the agent level and/or the ontology level. The agent history database 421 can store results from the processing server 419. The agent history database 421 can be updated in real time as new transcripts are created from agent-client interactions.

The automated ontology based AI routing system 415 can include an Interactive Voice Response (IVR) module 423, an ontology node assignment module 427, and agent selection processor 429.

The IVR module 423 can receive a real-time incoming interaction (e.g., call from a customer). The IVR module 423 can ask the customer an open ended question as to why they are calling. The intent for the call, as can be determined by the automated ontology system, can be detected from the customer's answer to the open ended question. In this manner, there may be no limit on the customer with “choose from this short list”, but rather to ask an open-ended, long response of why they are calling, avoiding restricting the customer into a rigid, narrow, inappropriate category. The customer's response can be near to one of the nodes of the ontology, to allow specificity and/or the ability to aggregate agent performance.

The ontology node assignment module 427 can take as input the call intent in the IVR module 423 and assign a corresponding node of the ontology (e.g., a node that matches or substantially matches the intent for the call).

The agent selection processor 429 can take as input an available agent list, agent performance history data and the appropriate node of the ontology. Using the call intent as categorized with the ontology, and the historical performance of the available agents on the current region, the agent selection processor 429 can select an agent that has historically been successful to handle the incoming intent to route the customer too. In this manner, the ontology creation can be used to more accurately route the customer to a best (or substantially the best) agent. Whether the agent has been successful to handle the incoming intent can be based on expected customer satisfaction, expected resolve rate, expected handle time, and/or other agent quality metrics and scheduling criteria as are known in the art.

In some embodiments, the agent historical data is updated after the customer's call.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A method for automatically creating ontology for use with agent-client interaction systems, the method comprising:
receiving, by a computer, a plurality of transcripts, wherein each transcript includes agent and client interactions;
generating, by the computer, via a first large language model (LLM) intents based on the plurality of transcripts;
generating, by the computer, via a second LLM the ontology based on the intents,
mapping, by the computer, via a third LLM the intents based on the ontology;
determining, by the computer, via a fourth LLM phrases to add to the mapped intents based on the ontology to create a final ontology map, wherein the phrases are used in expressing the intent; and
transmitting, by the computer, the final ontology map to the agent-client interaction system for use with new interactions.

2. The method of claim 1, wherein the ontology comprises for each of the intents, a topic and a category, wherein each topic belongs to a category.

3. The method of claim 1 wherein each of the phrases has corresponding speaker turn information.

4. The method of claim 1, wherein determining the phrases further comprises:
i) extracting titles and phrases from a base ontology;
ii) extracting titles and speaker turns from the generated ontology,
iii) determining a similarity between the titles from the base ontology and titles from the generated ontology,
iv) selecting a predetermined number of titles that have a highest similarity,
v) for each selected title, creating a combined intent that includes phrases from the base ontology and title and speaker turn from the generated ontology to create a number of combined intents equal to the predetermined number, and
vi) determining a final ontology map via a fifth LLM that determines the phrases for each mapped intent after the fifth LLM processes the combined intents.

5. The method of claim 4 wherein the similarity is based on a cosine similarity.

6. The method of claim 1 further comprising:
receiving, by the agent-client interaction system, the final ontology map and a real-time interaction request;
determining, by the agent-client interaction system, an intent of the real-time interaction request;
mapping, by the agent-client interaction system, the intent to one or more topics, one or more categories, or both based on the final ontology map;
determining, by the agent-client interaction system, an agent that excels at the intent, the one or more topics, the one or more categories, or any combination thereof; and
automatically routing, by the agent-client interaction system, to the determined agent.

7. The method of claim 6 wherein determining an agent that excels at the intent is based on agent history with the intent, one or more topics, or the one or more categories sentiment, based on satisfaction or any combination thereof.

8. The method of claim 1 wherein creating the final ontology map further comprises:
for each intent in the final ontology map, renaming the intent based on a similarity between the intent and the corresponding phrases.

9. The method of claim 1 wherein upon receipt of the plurality of transcripts, each transcript is shortened to include a maximum number of client statements.

10. The method of claim 4 wherein the predetermined number is 3 or higher.

11. A system for automatically creating ontology for use with agent-client interaction systems, the system comprising:
a processor configured to receive a plurality of transcripts, wherein each transcript includes agent and client interactions;
generate via a first large language model (LLM) to generate intents based on the plurality of transcripts;
generate via a second LLM the ontology based on the intents,
map via a third LLM the intents based on the ontology;
determine via a fourth LLM phrases to add to the mapped intents based on the ontology to create a final ontology map, wherein the phrases are used in expressing the intent; and
the processor configured to transmit the final ontology map to the agent-client interaction system for use with new interactions.

12. The system of claim 11, wherein the ontology comprises for each of the intents, a topic and a category, wherein each topic belongs to a category.

13. The system of claim 11, wherein each of the phrases has corresponding speaker turn information.

14. The system of claim 11, wherein determining the phrases further comprises the processor configured to:
vii) extract titles and phrases from a base ontology;
viii) extract titles and speaker turns from the generated ontology,
ix) determine a similarity between the titles from the base ontology and titles from the generated ontology,
x) select a predetermined number of titles that have a highest similarity,
xi) for each selected title, create a combined intent that includes phrases from the base ontology and title and speaker turn from the generated ontology to create a number of combined intents equal to the predetermined number, and
xii) determine a final ontology map via a fifth LLM that determines the phrases for each mapped intent after the fifth LLM processes the combined intents.

15. The system of claim 14 wherein the similarity is based on a cosine similarity.

16. The system of claim 11, further comprising:
receive, by the agent-client interaction system, the final ontology map and a real-time interaction request;
determine, by the agent-client interaction system, an intent of the real-time interaction request;
map, by the agent-client interaction system, the intent to one or more topics, one or more categories, or both based on the final ontology map;
determine, by the agent-client interaction system, an agent that excels at the intent, the one or more topics, the one or more categories, or any combination thereof; and
automatically route, by the agent-client interaction system, to the determined agent.

17. The system of claim 11, wherein determine an agent that excels at the intent is based on agent history with the intent, one or more topics, or the one or more categories sentiment, based on satisfaction or any combination thereof.

18. The system of claim 11, wherein creating the final ontology map further comprises:
for each intent in the final ontology map, renaming the intent based on a similarity between the intent and the corresponding phrases.

19. The system of claim 11, wherein upon receipt of the plurality of transcripts, each transcript is shortened to include a maximum number of client statements.

20. The method of claim 14 wherein the predetermined number is 3 or higher.
